(19) United States
(12) Patent Application Publication
(10) Pub. No.: US 2004/0215437 A1
(43) Pub. Date: Oct. 28, 2004

(54) System and method for improved accuracy of standard cell timing models

(76) Inventor: Chinsong Sul, Mountain View, CA (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/421,522

(22) Filed: Apr. 22, 2003

(51) Int. Cl. G06F 17/50

(52) U.S. Cl. 703/19

(57) ABSTRACT

A computer-based method for estimating cell performance is provided. The method comprises determining a correlation function between a known set of delay times over a range of load values of a first cell and a known set of delay times over the range of load values of a second cell. The method further comprises calculating a delay time of the second cell at a predetermined load value based upon the correlation function and a known delay time of the first cell at the predetermined load value. In another embodiment, the method further comprises determining a generalized slew rate correlation function and calculating a new delay time of the second cell based upon the generalized slew rate correlation function as well.

### BACKGROUND OF THE INVENTION

Computer-Automated-Design (CAD) systems comprise a combination of hardware and software that enable an engineer to simulate the performance of electronic systems and circuits before implementing the design in a more permanent manner. One such area that uses CAD systems frequently is the design of Application Specific Integrated Circuits, or ASICs. ASICs are typically designed by using a CAD system to assemble building blocks into a circuit design. Once assembled, performance characteristics of the circuit design are calculated based upon the known performance characteristics of each building block. Since the building blocks, often referred to as cells, have known performance characteristics that are typically stored in a standard cell library, the CAD system can retrieve specific data from the standard cell library to calculate parameters of the circuit design performance.

FIG. 1 is an example of a representative portion of a standard cell library 100 used by typical CAD systems. A standard cell library 100 is a collection of precompiled information about the performance characteristics of typical cells when measured at typical environment conditions that are used often in circuit design. The CAD system will use the information stored in a standard cell library 100 to simulate the performance of a design circuit. One such performance characteristic that is of particular interest to design engineers is signal propagation delay (delay), sometimes referred to as cell rise time.

As shown in FIG. 1, a standard cell library 100 will have data about several different cells, such as for example, a set of NAND gates, NAND-1 101, and NAND-2 102. Additionally, other characteristics are varied as well, such as the slew rate with respect to NAND-3 103. The performance of the cells will also depend upon the conditions of the environment, i.e. temperature, humidity, etc. A typical standard cell library 100 will have performance characteristics based upon fast 110, nominal 111, and slow 112 conditions. Additionally, cell performance will depend upon the magnitude of the load 105 connected to the cell. The load 105 is typically measured in capacitance or in proportion to capacitance. Finally, with respect to delay, a standard cell library 100 will provide information for a logic-0 to logic-1 transition 122 and a logic-1 to logic-0 transition 121. By way of example, a CAD design calling for a NAND-2 cell with an arbitrary load value of 2 in a slow environment and a transition from logic-1 to logic-0 would retrieve the delay time of 0.027 μsec from the standard cell library 100 for use in calculating the design circuit performance.

In addition to the data described above with respect to a standard cell library 100, manufacturers will also typically provide data about the delay time of a cell based upon varying slew rates. The slew rate of a cell, sometimes referred to as transition time, is the ratio of the rate at which an output signal will transition from one signal level to another with respect to the rate at which the input signal to the cell will transition from one signal level to another. Since cells are often connected in series, the output signal of one cell is often the input signed to the next cell. Thus, the delay time of a cell will vary depending upon the slew rate of the input signal. Therefore, the standard cell library 100 will typically provide data for different input slew rates, such as NAND-1 103 with a slew rate of 0.9.

A problem with data accuracy arises, however, because of size and data limitations of a standard cell library 100. Storing performance characteristics for every possible load 105 would require a prohibitive amount of data storage space. Thus, by convention, only a few load 105 values, typically 5-6 per set of conditions, are stored for any particular cell in a standard cell library 100. The chosen representative load 105 values are called characterization points and are typically provided by component manufacturers. When a CAD system calls for a load 105 value that is not one of the characterization points stored in the standard cell library 100, an approximation must be made between the two closest characterization points. One conventional method for approximating values between characterization points is piecewise-linear approximation.

FIG. 2 is a graphical representation 200 of how piecewise-linear approximation is used to calculate a delay value for a particular load 204 that is not one of the characterization points 206. The graph 200 shows a plot of the delay 202 of an arbitrary cell against the load 204 connected to the arbitrary cell. The characterization points 206 are shown disposed upon an actual delay curve 205. The actual delay curve 205 is not completely known without extensive empirical testing, however, and is typically estimated by interpolating line segments based upon the characterization points 206. For example, a first set of characterization points 206 (the three lower load values) are used to interpolate a first line segment 208 and a second set of characterization points 206 (the three higher load values) are used to interpolate a second line segment 209. The two line segments 208 and 209 are then used to calculate a delay value for any load value.

In this example, given a chosen load value 230, the delay associated with this load value 230 will be at the actual delay 214. However, using piecewise-linear approximation, the interpolated line segment 208 yields a calculated delay 212. Unfortunately, this method reveals an error of the magnitude 110 between the actual delay 214 and the calculated delay 212. This error leads to further errors in simulating the performance of the design circuit using CAD systems.

### SUMMARY OF THE INVENTION

An embodiment of the invention is directed to a computer-based method for estimating cell performance. The method comprises determining a correlation function between a known set of delay times over a range of load values of a first cell and a known set of delay times over the range of load values of a second cell. The method further comprises calculating a delay time of the second cell at a predetermined load value based upon the correlation function and a known delay time of the first cell at the predetermined load value.

In another embodiment, the method comprises determining a slew rate correlation function between a known set of delay times over a range of load values for a first slew rate of a first cell and a known set of delay times over a range of load values for a second slew rate of the first cell and calculating a delay time of the first cell at the predetermined load value based upon the slew rate correlation function and the known delay time of the first cell at the predetermined load value.

Therefore, an efficient calibration method is provided to enhance accuracy of library cell timing models. The new method uses correlation functions to generate enhanced timing models that can be used in design optimization and timing analysis of ASIC and other related chips. The method can also be employed in conventional CAD tools for delay calculation.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a representative portion of a conventional standard cell library;

FIG. 2 is a graphical representation of a conventional method of approximating the delay time for a given load value for an arbitrary cell;

FIG. 3 is a representative plot of a set of characterization points of an arbitrary cell against a reference cell yielding a correlation function according to an embodiment of the invention;

FIG. 4 is a representative plot of a delay characterization curve for a reference cell according to an embodiment of the invention;

FIG. 5 is graphical representation of a method for calculating the delay time of an arbitrary cell based upon the correlation function of FIG. 3 and the delay characterization curve of FIG. 4 according to an embodiment of the invention;

FIG. 6 is a representative plot of a set of characterization points of an arbitrary slew rate against a reference slew rate yielding a slew-rate correlation function according to an embodiment of the invention;

FIG. 7 is a flow chart of a method for calculating the delay time of a cell according to an embodiment of the invention; and

FIG. 8 is a block diagram of a general-purpose computer system suitable for implementing an embodiment of the invention.

### DETAILED DESCRIPTION OF THE PREFERRED EMBODIMENT

The following discussion is presented to enable a person skilled in the art to make and use the invention. The general principles described herein may be applied to embodiments and applications other than those detailed below without departing from the spirit and scope of the present invention. The present invention is not intended to be limited to the embodiments shown, but is to be accorded the widest scope consistent with the principles and features disclosed or suggested herein.

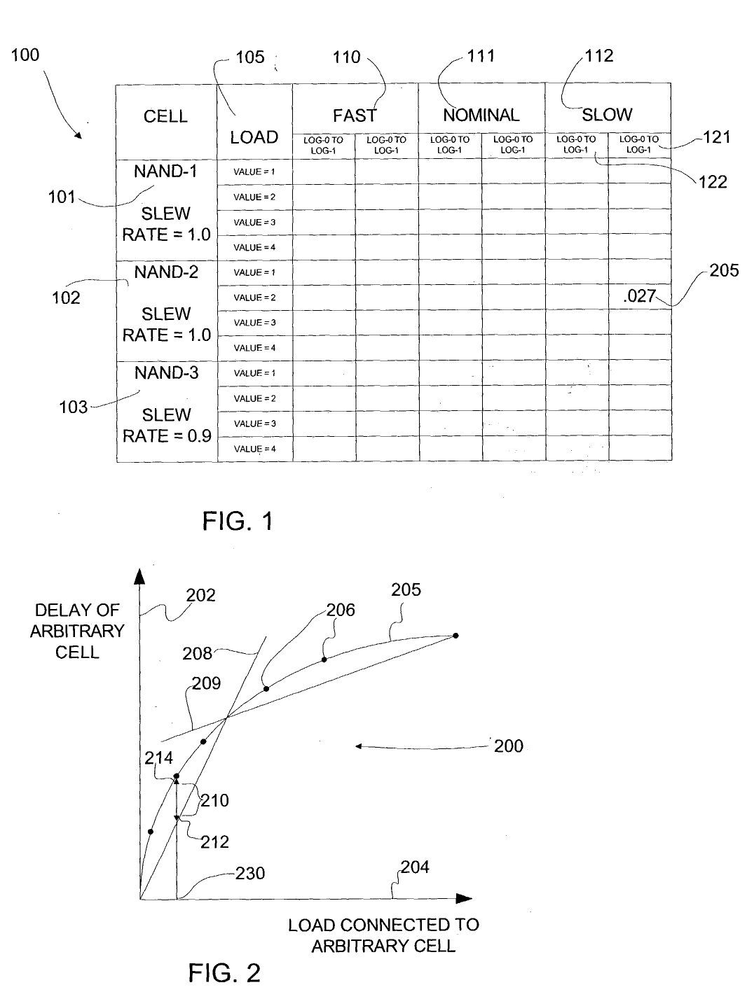

Standard cell libraries 100, as shown in FIG. 1 are widely available and used extensively in producing standard cell timing models with CAD systems. Each set of characterization points represents varying delay times with respect to changing one of the conditions, ie., varying the load connected, varying the input slew rate, etc. As was detailed in the background with respect to FIG. 1, several sets of characterization points are provided based upon differing conditions. The inventor has found that when comparing similar cells, i.e., a grouping of similar NAND gates, buffers, or inverters, a nearly linear relationship exists between changes in the cell delay time and changes in the connected load when other conditions are held constant. Similarly, a nearly linear relationship has also been found between changes in the cell delay time and changes in the input slew rate when all other conditions are held constant. These linear relationships, taken both separately and in conjunction with each other, can be used to improve standard cell timing models to provide greater accuracy of a delay time calculation.

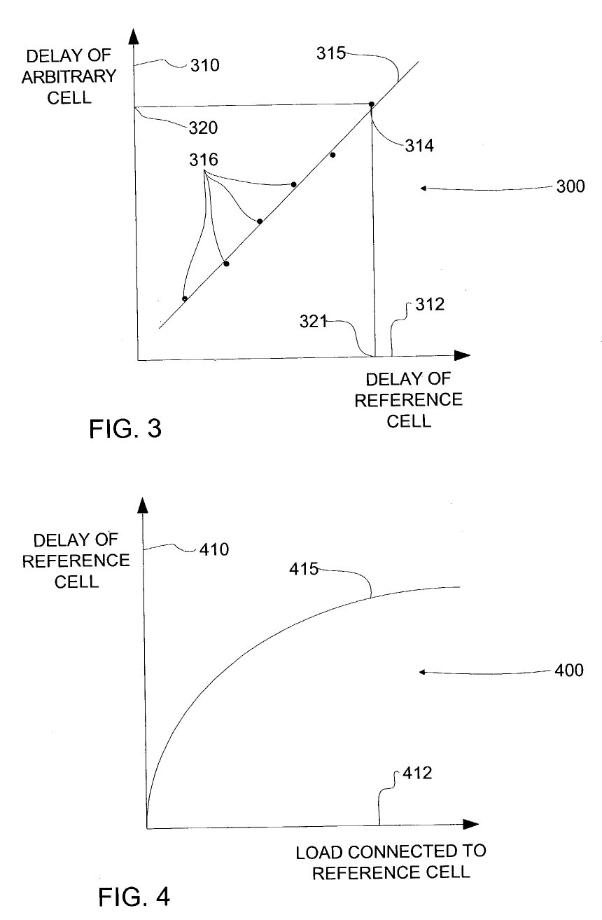

The first nearly linear relationship, which is between the delay times of different cells when the load connected to the cells is varied, is discussed with reference to FIG. 3. The graph 300 shows a plot the delay time 310 of an arbitrary cell against the delay time 312 of a reference cell over a set of characterization points with a varying load connection. A reference cell can be any cell in the standard cell library 100 and is typically a cell with a verifiably accurate set of characterization points. The reference cell is used as a baseline cell and used to determine the linear relationship between the delay times of all other cells in the standard cell library 100. Because cells in a standard cell library 100 typically have characterization points for the same set of 5-6 load values, the characterization points of the reference cell and an arbitrary cell can be plotted against each other as shown in FIG. 3. For example, the characterization point 314 for the fifth load value shows a delay 321 for the reference cell and a delay 320 for the arbitrary cell. As other characterization points 316 are also plotted in the graph 300 of FIG. 3, the linear relationship becomes apparent.

Once all characterization points 316 between the reference cell and the arbitrary cell have been plotted, the linear relationship can be determined by performing linear regression, sometimes referred to as a “best fit” line. Linear regression is a well-known mathematical process and will not be discussed further herein. The best fit line is the approximated linear relationship between the delay of the reference cell and the delay of the arbitrary cell over a given range of load values. This linear relationship, hereinafter called the correlation function 315, is stored in a database for future calculations. Storing just the correlation function is far more efficient than storing multiple characterization points for both the arbitrary cell and the reference cell. Expressed as a mathematical function, the correlation function 315 of FIG. 3 is as follows:

Arbitrary cell delay=f(Reference cell delay)

The correlation function 315 can be determined for any set of conditions, i.e., condition 1—fast, nominal, or slow, condition 2—logic-0 to logic-1 or logic-1 to logic-0, and condition 3—differing slew rates. Thus, several correlation functions 315 between the arbitrary cell and the reference cell are determined and stored in the database. Additionally, every cell in the standard cell library 100 can be analyzed in a similar fashion to determine the correlation function 315 for any given comparison to the reference cell. Likewise, each of these correlation functions 315 is stored in the database and even more storage efficiency is realized.

In order to utilize the correlation functions 315 now stored in the database, the reference cell is extensively tested to determine a highly accurate delay characterization curve to be used in calculating the delay time for any load value for a given arbitrary cell. FIG. 4 is a typical delay characterization curve that is determined by extensive testing. The graph 400 shows a plot of the reference cell delay 410 against the load 412 value connected to the reference cell that yields a reference-cell delay-characterization curve 415. Empirical testing for every load value yields a delay value that traces the reference-cell delay-characterization curve 415 with a high degree of accuracy. Testing is typically performed by physical measurement of delay times or using simulation software, such as SPICE, which is well known in the art. The reference-cell delay characterization curve 415, as shown in FIG. 4, represents a delay as a mathematical function of a given load, i.e.

Reference cell delay=g(load)

Note that the function g is a nonlinear and is typically implemented by a lookup table. The simulated values of the load are used as entries in the lookup table. A simple interpolation function can be used to calculate delay between successive lookup delay values if finer load values are required.

Once the correlation function 315 and the delay characterization curve 415 are known, calculating the delay time of an arbitrary cell is simple:

Arbitrary cell delay(load)=f(Reference cell delay)

and

Reference cell delay(load)=g(load)

therefore,

Arbitrary cell delay(load)=f((Reference cell delay)(g(load))

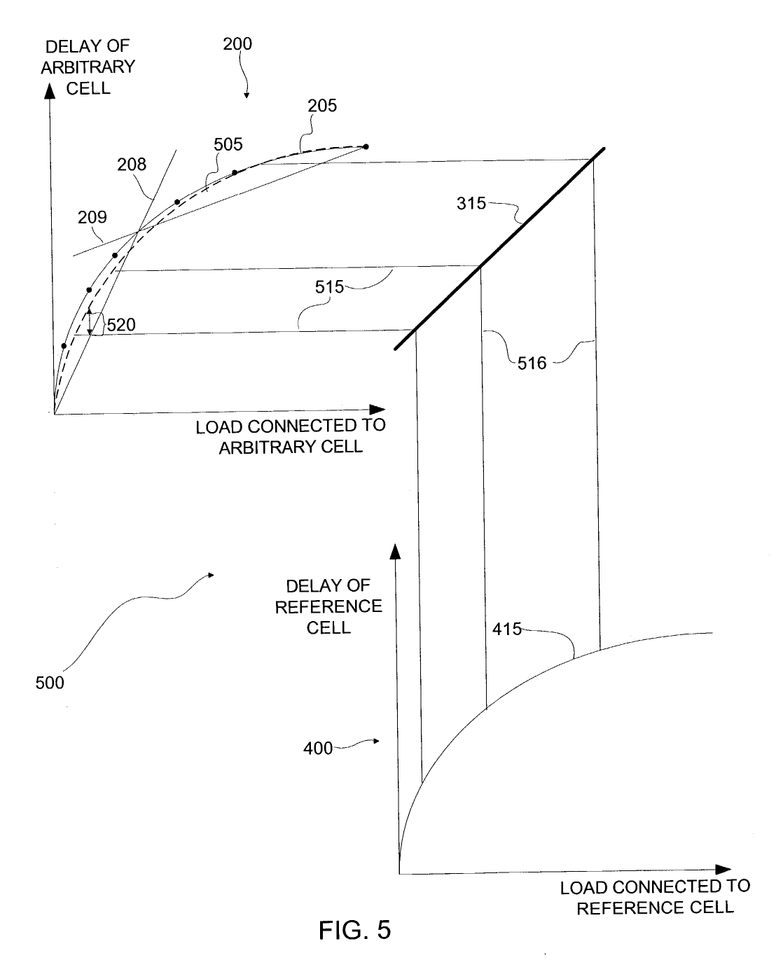

Thus, the delay time for any arbitrary cell in the standard cell library 100 can be calculated using the correlation function 315 and the reference cell delay characterization curve 415 when the load connected to the arbitrary cell is known. This calculation is described in greater detail with respect to FIG. 5.

FIG. 5 is a graphical representation 500 of the above equations. The delay characterization curve 205 of FIG. 2 of an arbitrary cell is shown in an upper graph 200. A lower graph 400, showing the reference cell delay characterization curve 415 as shown in FIG. 4 is plotted in correlation to the correlation function 315 of FIG. 3. The correlation function 315 is also plotted in correlation to the delay characterization curve 205. In this example, the correlation function 315 and the reference-cell delay-characterization curve 415 are the functional relationships between the chosen reference cell and an arbitrary cell at a given set of conditions, such as nominal, logic-0 to logic-1, and slew rate=1.0. Therefore, for a chosen load, the arbitrary cell delay can be calculated as a function of the correlation function 315 and the reference-cell delay characterization curve 415.

Graphically, the functions are traced using lines 515 and 516 to determine the arbitrary cell delay. Line 515 represents the function relating the reference-cell delay-characterization curve 415 and line 516 represents the function relating the correlation function 315. As is shown in FIG. 5, calculations over a range of load values yields an approximated delay curve 505 that more closely resembles the actual delay characterization curve 205 as compared to the line segments 208 and 209 that are used in the piecewise-linear approximation method. In the example for the load value of the traced lines 515 and 516, the improvement in approximating the delay time is shown by the magnitude 520.

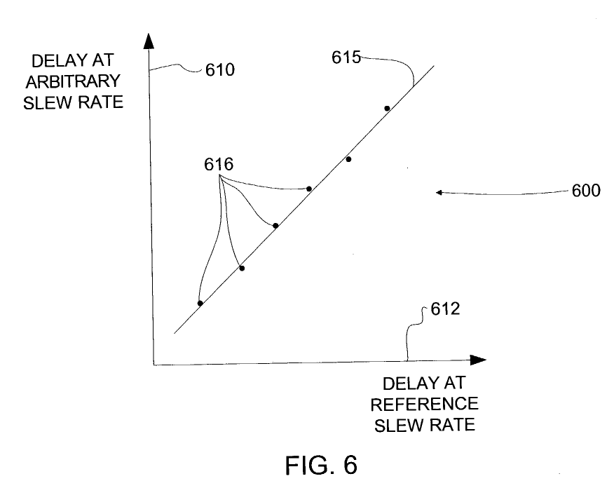

The second linear relationship, which is between the delay times of the same cell at two different input slew rates when the load connected to the cell is varied, is discussed with reference to FIG. 6. The graph 600 shows a plot of the delay time 610 of a cell at an arbitrary slew rate against the delay time 612 of the same cell at a reference slew rate over a range of load values. A reference slew rate, much like the reference cell described above, can be any slew rate chosen from the sets of characterization points in the standard cell library 100 (FIG. 1) for a given cell and is typically the median slew rate with a verifiably accurate set of characterization points. The reference slew rate is used to determine the linear relationship between all other slew rates for the chosen cell. Again, because cells in a standard cell library 100 typically have characterization points for the same set of 5-6 load values, the characterization points of the reference slew rate and an arbitrary slew rate can be plotted against each other as shown in FIG. 6. As these characterization points 616 are plotted in the graph 600, and the linear relationship again becomes apparent.

Once all characterization points 616 between the reference slew rate and the arbitrary slew rate have been plotted, the linear relationship can again be determined by performing linear regression. Here, the best fit line is the approximated linear relationship between the delay of the cell at a reference slew rate and the delay of the same cell at an arbitrary slew rate over a given range of load values. This linear relationship which is expressed as a slope k and a constant c, hereinafter called the slew rate correlation function 615, is also stored in a database for future calculations.

For any given cell in the standard cell library 100, the slew-rate correlation functions 615 can be used to determine a delay time associated with one slew rate as a function of delay time associated with the delay reference slew rate, i.e.

delay_slew rate_{—}1=k_{—}1*delay_reference_slew_rate+c_{—}1,

delay_slew rate_{—}2=k_{—}2*delay_reference_slew_rate+c_{—}2,

. . .

delay_slew rate_{—}j=k_{—}j*delay_reference_slew_rate+c_{—}j, where k_{—}j=1 and c_{—j=}0, if the jth slew rate is selected as a reference

. . .

delay_slew_rate_(n−1)=k_(n−1)*delay_reference_slew_rate+c_(n−1),

delay_slew_rate_{—}n=k_{—}n*delay_reference_slew_rate+c_{—}n

where n is the number of slew rates available in the standard cell library 100 and delay_slew_rate_n is the nth best fit line determined from linear regression. By performing linear regression on all k_ns and c_ns over the given range of slew rates, two linear functions k(slew_rate) and c(slew_rate) are obtained which approximate the delay time associated with any slew rate:

k=b_{—}1*slew_rate+b_{—}2,

c=b_{—}3*slew_rate+b_{—}4.

Where b_{—}1 is the slope and b_{—}2 is the x-axis crossing point of the best fit line for the k_ls and b_{—}3 is the slope and b_{—}4 is the y-axis cross point for the c_ls. The pair of functions (k,c) are called a generalized slew rate correlation function. The generalized slew rate correlation function specifies a slew rate correlation function 615 of an arbitrary slew rate. That is,

delay_slew_rate_arbitrary=k*delay_reference_slew_rate+c.

The generalized slew rate correlation function can be used to modify the delay time previously calculated for the arbitrary cell in order to reflect a slew rate effect. For example, in one embodiment of the invention, the generalized slew rate correlation function is used in conjunction with the correlation function 315 as follows:

Arbitrary cell delay(load, slew_rate)=k*Arbitrary cell delay(load)+c,

where

k=b_{—}1*slew_rate+b_{—}2,

c=b_{—}3*slew_rate+b_{—}4.

The above-described correlation functions 315 and 615 and the generalized slew rate correlation function can be used independently or in conjunction with each other to improve the accuracy of standard cell timing models.

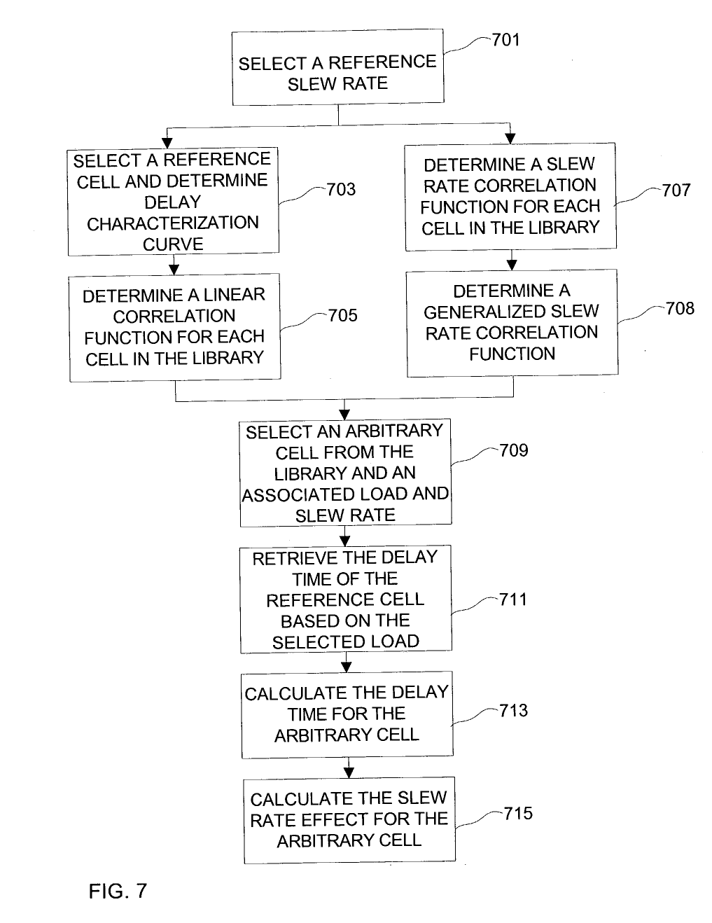

A computer-based method for estimating a cell performance is described with respect to FIG. 7 according to an embodiment of the invention. The method comprises steps that may be embodied in computer-executable instructions stored on a computer-readable medium and operable to perform the tasks described herein.

According to one such embodiment, the method comprises two sets of steps. The first set of steps is directed to preparing manufacturer provided data, i.e., characterization points in a standard cell library 100 to be used in calculating an arbitrary cell's delay characteristics. The first step is selecting a suitable reference slew rate for each cell within a standard cell library 100 at step 701. A suitable reference slew rate will typically be a slew rate which is similar to the average slew rate of each cell in the cell library 100. This step minimizes the number of correlation functions needed to be calculated in order to determine the delay of an arbitrary cell in later steps.

Next, a suitable reference cell is selected for each set of cells in the cell library 100 at step 703. Upon selecting a suitable reference cell, extensive empirical testing is performed to obtain a suitable delay characterization curve for the reference cell. The delay characterization curve may be stored in a computer database and implemented as a lookup table for required calculations. Once the delay characterization curve is determined, the next step is to determine a correlation function 315 for each cell in the standard cell library 100 at step 705. Furthermore, a set of slew rate correlation functions 615 and the corresponding generalized slew rate correlation function for each cell in the standard cell library 100 is determined at step 707 and 708 respectively which may be carried out simultaneous to steps 703 and 705. Now, appropriate data relationships, i.e., the correlation functions 315 and 615 and the generalized slew rate correlation function are assembled such that a cell's delay characteristics may be calculated.

The second set of steps are directed to utilizing the correlation functions 315 and the generalized slew rate correlation function to calculate a delay characteristic for any arbitrary cell in the standard cell library 100. At step 709 an arbitrary cell is selected along with a load value and a slew rate. Once these parameters are selected, appropriate functions, i.e., the correlation function 315 and the generalized slew rate correlation function can then be retrieved from the computer database. At step 713, the delay time associated with the selected load that is stored in the lookup table representing the reference cell delay characterization curve 415 is retrieved. Once each of these retrievals has occurred, the delay time for the arbitrary cell is calculated at step 715 using the appropriate correlation function 315 that was determined in step 705. Then, in step 715, the effect of the slew rate can be calculated using the appropriate generalized slew rate correlation function that was determined in step 708.

In another embodiment of the invention, the second set of steps may be repeated for each cell in a plurality of cells that make up a typical circuit. In this way, the total delay time of the circuit may be calculated based upon the individual delay time calculations of each cell.

In still another embodiment of the invention, the first set of steps may be used to verify and asses the accuracy of data that is stored in a standard cell library 100. For example, the correlation function 315 that is calculated by linear regression will have an associated standard deviation. Standard deviation of linear regression indicates how closely a relationship of a set of characterization points is to being linear. A small standard deviation is an indication that the characterization points have a relationship that is close to linear. A large standard deviation suggests that one or more characterization points are erroneous. A large standard deviation is an indication that abnormal timing behavior may be evident i.e., that the characterization points may be inaccurate. Consequently, when a cell with large standard deviation is used in a design, then this may introduce delay errors into the simulation. In the same manner, the slew rate correlation functions 615 may be analyzed to determine the accuracy of the characterized points at each slew rate.

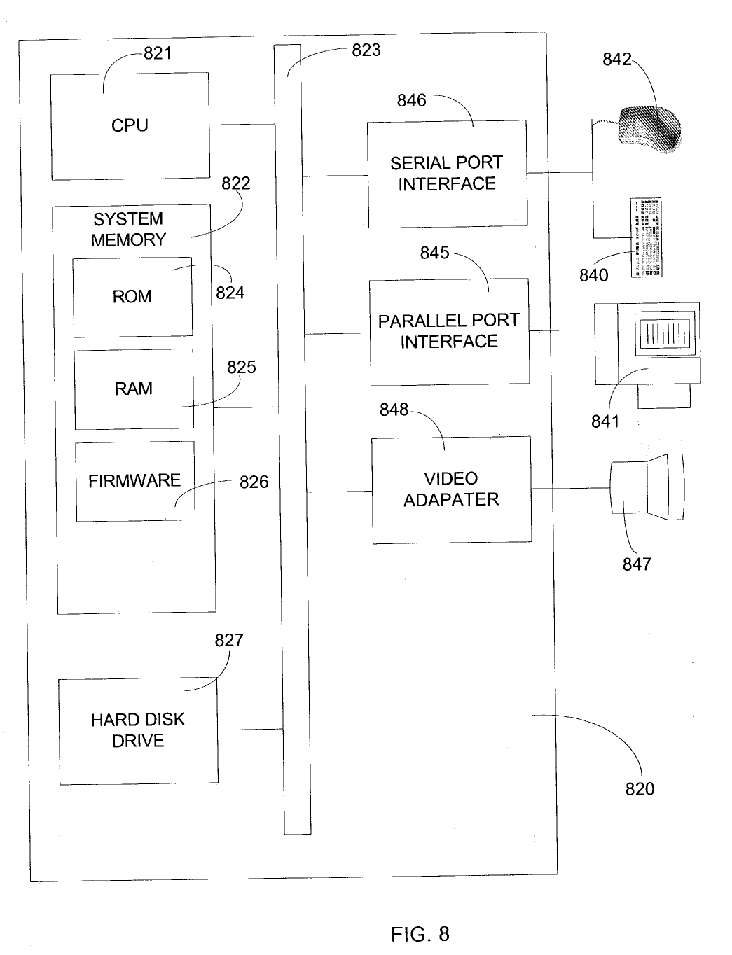

FIG. 8 is a block diagram of a general-purpose computing device in the form of a conventional personal computer 820 suitable to be used in conjunction with various embodiments of the invention, for example, to execute the method of FIG. 7. The personal computer 820 includes a processing unit 821, a system memory 822, and a system bus 823. The system bus 823 couples the various system components, including the system memory 822, to the processing unit 821. The system bus 823 may be any of several types of busses including a memory bus, a peripheral bus, and a local bus using any of a variety of bus architectures.

The system memory 822 includes a read-only memory (ROM) 824, a random-access memory (RAM) 825, and firmware 826, which contains the basic routines that help to transfer information between devices of the personal computer 820. The personal computer 820 further includes a hard disk drive 827 that is also connected to the system bus 823 through a hard disk controller (not shown). Additionally, optical drives, CD-ROM drives, floppy drives (not shown) may be connected to the system bus 823 through respective drive controllers (not shown) as well.

A number of program modules may be stored on the hard disk drive 827 or in the ROM 824 or RAM 825, including an operating system, one or more application programs, and computer-executable instruction operable to perform the methods of the invention described above. A user (not shown) may enter commands and information into the personal computer 820 through input devices such as a keyboard 840 and pointing device 842. These input devices as well as others not shown are typically connected to the system bus 823 through a serial port interface 846. Other interfaces (not shown) include Universal Serial Bus (USB) and parallel ports. A monitor 847 or other type of display device may also connect to the system bus 823 via an interface such as a video adapter 848.

We claim:

1. A method for estimating cell performance, the method comprising:
determining a correlation function between a known set of delay times of a first cell over a range of load values and a known set of delay times of a second cell over the range of load values; and
calculating a delay time of the second cell at a predetermined load value based upon the correlation function and a known delay time of the first cell at the predetermined load value.

2. The method of claim 1 wherein determining the correlation function comprises calculating a linear regression line based upon the known set of delay times over the range of load values for the first cell and the second cell.

3. The method of claim 1 wherein the known set of delay times are derived from a fast propagation rate, a nominal propagation rate, and a slow propagation rate.

4. The method of claim 3 wherein the correlation function is based upon a known set of delay times for the first and second cells that are derived from the same propagation rate.

5. The method of claim 1 wherein the known set of delay times are derived from a transition from logic-1 to logic-0 and a transition from logic-0 to logic-1.

6. The method of claim 5 wherein the correlation function is based upon a known set of delay times for the first and second cells that are derived from the same transition.

7. The method of claim 1 wherein the known set of delay times derived from different input slew rates.

8. The method of claim 7 wherein the correlation function is based upon a known set of delay times for the first and second cells that are derived from the same input slew rate.

9. The method of claim 1 further comprising storing the correlation function in a database.

10. The method of claim 1 further comprising storing the known delay time of the first cell at the predetermined load value in a database.

11. The method of claim 1 further comprising:
determining a slew rate correlation function between a known set of delay times over a range of load values for a first slew rate of the second cell and a known set of delay times over a range of load values for a second slew rate of the second cell; and
calculating a new delay time of the second cell at the predetermined load value based upon the correlation function, the slew rate correlation function, and the known delay time of the first cell at the predetermined load value.

12. The method of claim 11 further comprising storing the slew rate correlation function in a database.

13. The method of claim 11 further comprising:
determining a generalized slew rate correlation function based on the determined slew rate correlation function ; and
calculating a new delay time of the second cell at the predetermined load value based upon the correlation function, the generalized slew rate correlation function, and the known delay time of the first cell at the predetermined load value.

14. The method of claim 1 further comprising storing the generalized slew rate correlation function in a database.

15. A computer-readable medium having computer-executable instructions operable to calculate a delay time of a cell, the computer-executable instructions operable for:
determining a correlation function between a known set of delay times over a range of load values of a first cell and a known set of delay times over the range of load values of a second cell;
determining a slew rate correlation function between a known set of delay times over a range of load values for a first slew rate of the second cell and a known set of delay times over a range of load values for a second slew rate of the second cell; and
calculating a delay time of the second cell at a predetermined load value based upon the correlation function, the slew rate correlation function, and a known delay time of the first cell at the predetermined load value.

16. The computer-readable medium of claim 15 further comprising computer-executable instructions operable for:
determining a generalized slew rate correlation function based upon the slew rate correlation function; and
calculating a delay time of the second cell at a predetermined load value based upon the correlation function, the generalized slew rate correlation function, and a known delay time of the first cell at the predetermined load value.

17. A computer-based method for simulating cell performance, the method comprising:
determining a slew rate correlation function between a known set of delay times over a range of load values for a first slew rate of a first cell and a known set of delay times over a range of load values for a second slew rate of the first cell; and
calculating a delay time of the first cell at a predetermined load value and a predetermined slew rate based upon the slew rate correlation function, and a known delay time of first cell at the predetermined load value and at the second slew rate.

18. The method of claim 17, further comprising:
determining a correlation function between a known set of delay times over a range of load values of the first cell and a known set of delay times over the range of load values of a second cell; and
calculating a new delay time of the first cell at a predetermined load value based upon the correlation function, the generalized slew rate correlation function and a known delay time of the first cell at the predetermined load value and at the second slew rate.

19. A computer-readable medium having computer-executable instructions operable to calculate a delay time of a cell, the computer-executable instructions operable for:
determining a slew rate correlation function between a known set of delay times over a range of load values for a first slew rate of a first cell and a known set of delay times over a range of load values for a second slew rate of the first cell; and
determining a correlation function between a known set of delay times over a range of load values of the first cell and a known set of delay times over the range of load values of a second cell; and
calculating a delay time of the first cell at a predetermined load value based upon the correlation function, the slew rate correlation function, and a known delay time of the first cell at the predetermined load value at the second slew rate.

20. A computer-based method for determining the delay time for a first cell at a predetermined load, the method comprising:
retrieving from a database, a known correlation function between the delay time of the first cell and the delay time of a reference cell;
retrieving from a database, a known delay time of the reference cell at the predetermined load; and
calculating the delay time of the first cell based upon the correlation function and the known delay time of the reference cell at the predetermined load.

21. The method of claim 20, further comprising:
retrieving from a database, a known generalized slew rate correlation function and
calculating the delay time of the first cell based upon the correlation function, the generalized slew rate correlation function, and the known delay time of the reference cell at the predetermined load.

22. A method for modifying data in a cell library, the method comprising:
selecting a first cell in the cell library as a reference cell;
selecting a second cell in the cell library as an arbitrary cell;
determining a correlation function and a standard deviation by using linear regression between data of the reference cell and the data the arbitrary cell; and
storing the correlation function in the cell library.

23. The method of claim 22, further comprising determining that the data for the arbitrary cell is erroneous if the standard deviation of the correlation function exceeds a predetermined threshold.

24. The method of claim 22, further comprising:
determining a correlation function and a standard deviation by using linear regression between data of the reference cell and the data of all other cells in the cell library; and
storing each correlation function in the cell library.

25. The method of claim 22, further comprising:
selecting a first slew rate of the arbitrary cell as a reference slew rate;
selecting a second slew rate of the arbitrary cell as an arbitrary slew rate;
determining a slew rate correlation function and a standard deviation by using linear regression between data of the reference slew rate and the arbitrary slew rate;
determining a generalized slew rate correlation function based on the slew rate correlation function; and
storing the generalized slew rate correlation function in the cell library.

26. The method of claim 25, further comprising determining that the data for the arbitrary slew rate of the arbitrary cell is erroneous if the standard deviation of the slew rate correlation function exceeds a predetermined threshold.

27. The method of claim 25, further comprising:
determining a slew rate correlation function and a standard deviation by using linear regression between data of the reference slew rate and the data of all other slew rates for the arbitrary cell;
determining a generalized slew rate correlation function based on the slew rate correlation function; and
storing the generalized slew rate correlation function in the cell library.

28. A system for calculating the delay time of a cell, the system comprising:
a library having delay characteristics for a plurality of cells, wherein one cell in the library is a reference cell;
a first database storing a correlation function between the delay characteristics of the reference cell and every other cell in the library;
a second database storing a delay time of the reference cell for a plurality of predetermined loads; and
a calculator coupled to the library and to the first and second database, the calculator operable to calculate the delay time of an arbitrary cell in the library based upon data retrieved from first and second databases.

29. The system of claim 28, further comprising a third database storing a generalized slew rate correlation function obtained from a set of slew rate correlations functions of each cell.

30. The system of claim 29 wherein the calculator is operable to calculate the delay time of the arbitrary cell based upon the data retrieved from the first, second, and third databases.

31. A cell library comprising:
a first database storing a plurality of correlation functions, each correlation function corresponding a known set of delay times of a reference cell to a known set of delay times of a corresponding cell; and
a second database storing a plurality of delay times, each delay time corresponding to a load value for the reference cell.

32. The cell library of claim 31 further comprising a third database containing a plurality of slew rate correlation functions, each slew rate correlation function corresponding a known set of delay times of a cell at a first input slew rate to a known set of delay times of the cell at reference slew rate.
